(19) United States
(12) Patent Application Publication
(10) Pub. No.: US 2025/0383458 A1
(43) Pub. Date: Dec. 18, 2025

(54) SEMICONDUCTOR RADIATION SENSOR DEVICE AND METHOD OF TRAINING AN ARTIFICIAL NEURAL NETWORK FOR SIGNAL PROCESSING

(71) Applicant: DANMARKS TEKNISKE UNIVERSITET, Kongens Lyngby (DK)

(72) Inventor: Irlan KUVVETLI, Kongens Lyngby (DK)

(21) Appl. No.: 18/875,794

(22) PCT Filed: Jun. 26, 2023
(86) PCT No.: PCT/EP2023/067303

§ 371 Date: Dec. 17, 2024

(30) Foreign Application Priority Data
Jun. 27, 2022 (EP) 22181314.0

(51) Int. Cl. G01T 1/24; G01T 1/29

(52) U.S. Cl. CPC G01T 1/247; G01T 1/2985

(57) ABSTRACT

A semiconductor radiation sensor device for characterizing X-ray and/or gamma-ray radiation has: a converter with physically spaced semiconductor sensors to convert incident X-ray and/or gamma-ray photons into electron-hole pairs; an electric field generator to apply an electric field to the sensors, thereby creating signals representative of a movement of charge carriers in the sensors; a readout circuitry to read out the signals; and a processing unit connected to the readout circuitry. The processing unit estimates an interaction time and a three-dimensional interaction position of an event in the converter by processing the sensors signals. The processing unit has an artificial neural network trained to generate the estimated interaction time and the three-dimensional interaction position of the event based on a model of physical and geometrical sensors properties and based on simulated time-varying sensors charges. A method of training an artificial neural network to generate a three-dimensional characterization is also provided.

### CROSS-REFERENCE TO RELATED APPLICATIONS

The present application is the national phase entry of International Patent Application No. PCT/EP2023/067303, filed Jun. 26, 2023, which claims priority to European Patent Application No. 22181314.0, filed Jun. 27, 2022, the entire contents of both are hereby incorporated by reference.

### TECHNICAL FIELD

The present disclosure relates to a semiconductor radiation sensor device for characterizing X-ray and/or gamma-ray radiation. The disclosure further relates to a method of training an artificial neural network to generate a three-dimensional characterization of incoming single photons.

### BACKGROUND

Detection of X-rays and gamma-rays has a large number of important applications, such as national security, medical imaging, astrophysics in between 1 keV to 2 MeV, and gamma-ray imaging spectroscopy in between 100 keV to 100 MeV.

A three-dimensional cadmium zinc telluride (CZT) detector has previously been described in WO2015078902 and WO2018065024. Such a detector is useful for, for example, space applications and medical applications since it has both sub-mm position resolution and excellent energy resolution.

While these detectors can provide precise and valuable incident radiation information including type of interactions, they also require advanced signal processing and computational power. The final information has hitherto been provided by a cumbersome offline statistical analysis. Accuracy and speed of such radiation sensor system is limited by the performance of the readout electronics. In the known solutions, high capacity computational power is needed to handle the readout of a number of channels at a high frequency sampling of the three-dimensional sensor outputs. Currently signal processing and real-time analysis are strongly dependent on photon flux and data transfer rate. If data is instead processed remotely, for example, in a cloud-based computing system, a very high amount of data would have to be transferred between the 3D CZT detector and the computing system.

It would thus be beneficial to replace the slow and poor accuracy of the conventional readout systems with a more efficient, high precision, near-real time detector readout technology.

### SUMMARY

The present disclosure provides systems and methods for overcoming at least some of the inconveniences and drawbacks of the conventional readout systems for photon-by-photon detection and measurement systems.

The present disclosure relates to, according to a first embodiment, a semiconductor radiation sensor device for characterizing X-ray and/or gamma-ray radiation comprising:
a converter comprising a plurality of physically spaced semiconductor sensors configured to convert incident X-ray and/or gamma-ray photons into electron-hole pairs;
an electric field generator configured to apply an electric field to the plurality of physically spaced semiconductor sensors, thereby creating signals representative of a movement of charge carriers in the physically spaced semiconductor sensors;
a readout circuitry being configured to read out the signals from said plurality of semiconductor sensors; and
a processing unit connected to said readout circuitry, said processing unit being configured to estimate an interaction time and a three-dimensional interaction position of an event in said converter by processing the signals read out from the plurality of semiconductor sensors, wherein the processing unit comprises an artificial neural network (ANN) that has been trained to generate the estimated interaction time and the three-dimensional interaction position of the event based on a model of physical and geometrical properties of the plurality of semiconductor sensors and based on simulated time-varying charges on the plurality of semiconductor sensors. The processing unit may be configured to estimate an interaction time, a three-dimensional interaction position and deposited energy of the event.

By connecting the readout circuitry to a processing unit that has been trained in this way, a system is obtained, which can provide substantially real-time event characterization, which may include, for example, interaction types and positions, deposited energies and time stamps. The processing unit may thus be configured to estimate the interaction time and the three-dimensional interaction position of each event in substantially real-time by feeding the readout signals to an artificial neural network and obtaining the interaction time and the three-dimensional interaction position of the event. The processing unit and the artificial neural network may be local components of the system and may be configured to operate offline.

The presently disclosed semiconductor radiation sensor device can significantly improve the accuracy and speed relative to a conventional readout. The ANN based readout circuitry may be configured to monitor the whole sensor volume and accurately predict and extract the radiation information after each interaction. The ANN may therefore be adapted to be applied on randomly occurring radiation by monitoring signals from all of the physically spaced semiconductor sensors and extract information event by event. The event identification and characterization may extract interaction type(s), position(s), deposited energies, and time stamp(s) of any radiation interaction within the sensor device. The radiation sensor device may be adapted to identify which type of radiation occurred, whether one or more interactions occurred per radiation photon and whether an interaction occurred due to charged particles or due to electromagnetic radiation.

The presently disclosed semiconductor radiation sensor device comprising an artificial neural network that has been trained to generate the estimated interaction time and the three-dimensional interaction position of the event based on a model of physical and geometrical properties of the plurality of semiconductor sensors may be used to compensate for signal fluctuations and distortion, for example, due the non-uniform detector material properties, poor charge transport properties etc. The semiconductor sensors may be detector electrodes.

For radiation energies greater than 200 keV, in particular for polarized electromagnetic radiation, the ANN based semiconductor radiation sensor device may be adapted to extract the incident photon angle and the polarization degree for any interaction type, such as in particular during multiple interaction events such as Compton scattering or pair production.

The converter comprising a plurality of physically spaced semiconductor sensors may be implemented in various ways, for example, wherein the plurality of semiconductor sensors are cathode electrodes arranges on a first side of the converter, and wherein the converter has a second side opposite to the first side, wherein at least one anode electrode is arranged on the second side of the converter. Possible structures of such designs are shown in FIGS. 7A-D. FIG. 7A shows a double-sided cross-strip electrode implementation. FIG. 7B shows an implementation having a planar electrode on the backside and an M×N array of drift pixel electrodes. FIG. 7C shows an implementation having a planar electrode on the backside and an M×N array of pixel electrodes. FIG. 7D shows an implementation having a planar electrode on the backside and vertically extending anode electrodes. The total number of electrodes, and their dimensions, mutual distances on each side and to the opposing side, and materials used may be provided in any suitable way known to the skilled person as to provide a converter adapted for the intended use. Further, any suitable combination of converters in a sensor device according to the invention may also be envisaged by the skilled person. The plurality of semiconductor sensors may be drift electrodes. In the known CZT detectors the processing unit is typically configured to analyse the drift to estimate a location of an event. In particular the processing unit may be configured to continuously monitor electrical potentials of the plurality of physically spaced semiconductor sensors. Such analysis may comprise analysis triggered by a change on one sensor and then subsequent further monitoring of the other sensors. Provided that there may be many sensors and that the sensors need to be sampled with a very high frequency, it is typically not realistic to perform the processing in real-time.

The inventor of the presently disclosed semiconductor radiation sensor device for characterizing X-ray and/or gamma-ray radiation has realized that in order to make the new generation devices, including, for example three-dimensional CZT drift strip detectors, capable of characterizing events in substantially real-time, an option is to use a processing unit with an artificial neural network configured to estimate an interaction time and a three-dimensional interaction position of an event in said converter by processing the signals read out from the plurality of semiconductor sensors. Rather than calculating an interaction time and a three-dimensional interaction position, the artificial neural network is trained to recognize patterns of the monitored time series of signals to estimate the interaction time and position of the event. The model of physical and geometrical properties of the plurality of semiconductor sensors may be a theoretical interaction model capable of simulating the electric response of a single charge carriers moving in the CZT detector.

Since each type of semiconductor radiation sensor device may have an individual setup in terms of physical implementation, including sensor setup, materials etc., the present disclosure further describes that the artificial neural network is trained based on a model of physical and geometrical properties of the plurality of semiconductor sensors. Preferably, the model is a theoretical sensor model including a specific sensor type. If the artificial neural network is trained based on simulated 3D CZT detector data applied on the theoretical sensor model, the artificial neural network can be trained for a range of different sensor types and semiconductor radiation sensor devices.

The detailed description below describes in further detail the theory behind the model of physical and geometrical properties of the plurality of semiconductor sensors, the training of the artificial neural network as well as application and experimental data of the application of the artificial neural network in the semiconductor radiation sensor device.

The present disclosure further relates to a method of training an artificial neural network, the method comprising the step of:
providing an artificial neural network;
providing a model of a converter comprising a plurality of semiconductor sensors for converting incident X-ray and/or gamma-ray photons into electron-hole pairs, the model further comprising physical and geometrical properties of the plurality of semiconductor sensors;
providing simulated time-varying induced charge signals of incident X-ray and/or gamma-ray photons on the plurality of semiconductor sensors;
based on further simulations of the model of the converter and the simulated time-varying induced charge signals on the plurality of semiconductor sensors, extracting simulated read out signals from the plurality of semiconductor sensors; and
based on the simulated time-varying induced charge signals of incident X-ray and/or gamma-ray photons on the plurality of semiconductor sensors and the simulated read out signals from the plurality of semiconductor sensors, training the artificial neural network to generate a three-dimensional characterization of incoming single photons.

The method of training the artificial neural network may involve training the artificial neural network to generate estimated interaction times, deposited energies, interaction types and the three-dimensional interaction positions of events.

A person skilled in the art will recognize that the presently disclosed method of training an artificial neural network may be performed to train an artificial neural network used or comprised in a processing unit connected to readout circuitry of any embodiment of the presently disclosed semiconductor radiation sensor device for characterizing X-ray and/or gamma-ray radiation.

### DESCRIPTION OF THE DRAWINGS

Various embodiments are described hereinafter with reference to the drawings. The drawings are examples of embodiments and are intended to illustrate some of the features of the presently disclosed semiconductor radiation sensor device and method of training an artificial neural network, and are not limiting to the presently disclosed system and method.

FIG. 1 shows a schematic view of an embodiment of the presently disclosed semiconductor radiation sensor device for characterizing X-ray and/or gamma-ray radiation;

FIG. 2 shows an embodiment of a flowchart using the presently disclosed semiconductor radiation sensor device for characterizing X-ray and/or gamma-ray radiation;

FIG. 3 shows an embodiment of a conceptual setup of the presently disclosed semiconductor radiation sensor device for characterizing X-ray and/or gamma-ray radiation;

FIG. 4 shows an embodiment of a setup of electrodes and readout circuitry;

FIG. 5 shows an embodiment of a conceptual setup of electrodes and readout circuitry;

FIG. 6 shows a further example of a setup of electrodes and readout circuitry;

FIG. 7A-D show a number of embodiments of electrodes;

FIG. 8 shows a detailed example of a readout circuitry of the present disclosed semiconductor radiation sensor device;

FIG. 9 shows an embodiment of a signal converter for converting a charge to a current;

FIG. 10 shows an electrical equivalent of the signal converter of FIG. 9;

FIG. 11 shows an embodiment of a basic configuration of a charge sensitive preamplifier;

FIG. 12 shows an example of signal of charges on the electrodes;

FIG. 13 shows an experimental comparison of characterization using the presently disclosed semiconductor radiation sensor device using an artificial neural network and the previously used offline characterization;

FIG. 14 shows a flow chart of a method according to an embodiment of the presently disclosed method of training an artificial neural network;

FIG. 15 shows an example of cyclic buffers used for sampling signals from the plurality of physically spaced semiconductor sensors;

FIG. 16 shows an example of an output of a theoretical sensor specific model, more precisely the charge movement after an event; and

FIG. 17 shows a further schematic embodiment of the presently disclosed radiation sensor device.

### DETAILED DESCRIPTION

The present disclosure relates to a semiconductor radiation sensor device for characterizing X-ray and/or gamma-ray radiation. The semiconductor radiation sensor device may, alternatively, be referred to as a semiconductor sensor device or sensor device for short. The sensor device comprises one or more converters configured to convert incident X-ray and/or gamma-ray photons into electron-hole pairs, which is described in further detail below. The technology may be implemented by means of a plurality of physically spaced semiconductor sensors, typically arranged in a three-dimensional structure, and an electric field generator configured to apply an electric field to the plurality of physically spaced semiconductor sensors, thereby creating signals representative of a movement of charge carriers in the physically spaced semiconductor sensors. A readout circuitry may be used to read out the signals from said plurality of semiconductor sensors. As a person skilled in the art would understand, there are several ways of implementing the readout circuitry. One example, which is described in further detail below, is to connect anodes and cathodes to different potentials, which will cause radiation-induced carriers to drift in the sensor device. The signals may then be fed to amplifiers. The sensor device further comprises a processing unit, which receives signals from the readout circuitry. The processing unit is configured to estimate an interaction time and a three-dimensional interaction position of an event in said converter by processing the signals read out from the plurality of semiconductor sensors, wherein the processing unit comprises an artificial neural network that has been trained to generate the estimated interaction time and the three-dimensional interaction position of the event based on a model of physical and geometrical properties of the plurality of semiconductor sensors and based on simulated time-varying charges on the plurality of semiconductor sensors.

An event within the present disclosure can be defined as the interaction between an X-ray or gamma-ray photon and an electron in the converter element creating an electron hole pair.

In a semiconductor radiation sensor device, radiation is deposited as charges in the detecting material. The deposited charge can be proportional to the energy of the photon. There are different types of interactions, including photoelectric absorption PE, Compton scattering CS and pair production PP. Photoelectric absorption and pair production dominate at low (<100 keV) and high energies (>1022 keV) respectively, while Compton scattering is the dominant interaction mechanism at intermediate energies (0.100 keV to 1 MeV). All three interactions are suitable for energy determination. Accordingly, in one embodiment of the presently disclosed semiconductor radiation sensor device, the processing unit is configured to estimate an energy level of an X-ray or gamma-ray photon.

Semiconductor detectors are a type of solid-state detector that employs a semiconducting material for detecting and measurement of radiation purposes. In a semiconductor a small input of energy can excite an electron from the valence to the conductive band. A vacancy, known as a hole, is then left in the valence band. The hole acts as a net positive charge, and the pair of charge carriers are known as an electron-hole pair. The energy needed to generate an electron-hole pair in a semiconducting medium is generally very small. By applying an electrical field to the semiconducting material of the semiconductor radiation sensor device, a movement of the charge carriers is obtained. The electrons will move toward the highest potential (anodes) while the holes move toward the lowest potential (cathodes).

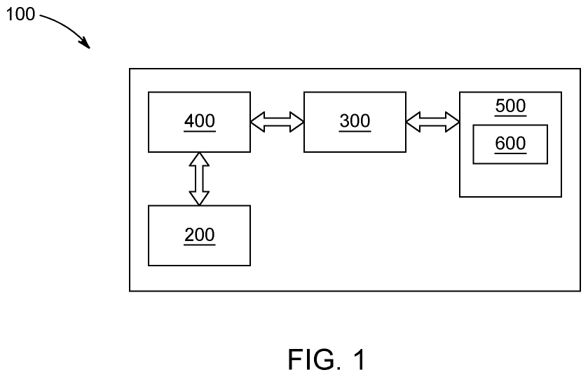

FIG. 1 shows a schematic view of an embodiment of the presently disclosed semiconductor radiation sensor device (100) for characterizing X-ray and/or gamma-ray radiation. The semiconductor radiation sensor device (100) comprises a converter (400), an electric field generator (200), a readout circuitry (300) and a processing unit (500) comprising or connected to an artificial neural network (600).

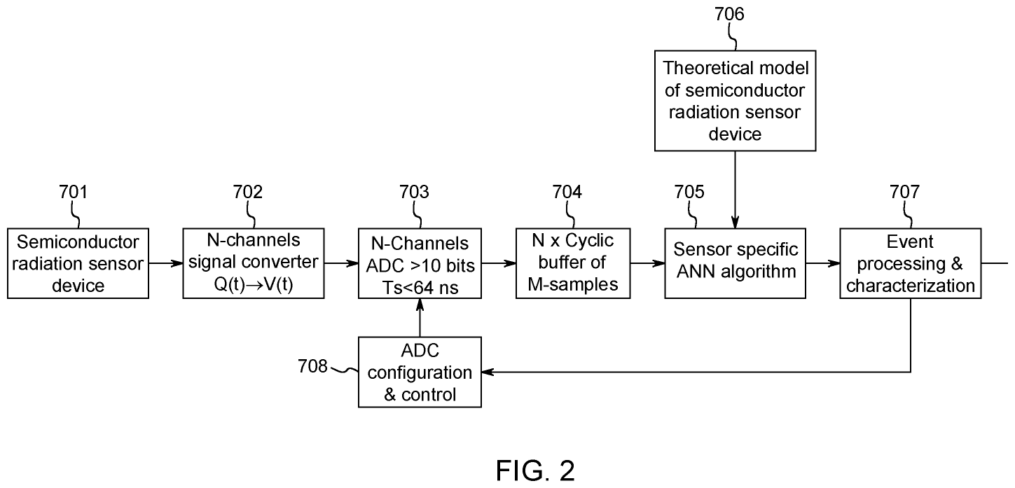

FIG. 2 shows a flowchart of one example for operation of the presently disclosed semiconductor radiation sensor device for characterizing X-ray and/or gamma-ray radiation. As can be seen, a semiconductor radiation sensor device first receives/senses X-ray and/or gamma-ray radiation (701) in the semi-conducting material provided in the electrical field. The charges in the converter are then converted to currents or voltages (702). An ADC then converts the analog voltages/currents to digital signals (703). The data is then further arranged and prepared for the artificial neural network (704) in a cyclic buffer. The signals/data read out from the converter is then used by an artificial neural network (705) that has been trained to generate the estimated interaction time, deposited energy and the three-dimensional interaction position of the event based on a model (706) of physical and geometrical properties of the plurality of semiconductor sensors. The processing unit can thereby estimate an interaction time and a three-dimensional interaction position of an event in said converter (707). There may be continuous adaptation of ADC (708). The ADC configuration and control may also comprise triggering and input data control between the converter and the cyclic buffer autonomously. It may be configured to monitor signal conditions of converted sampled signals for specific electrode signals conditions in order to start the ANN signal processing for an event.

The sensor signals may be converted and saved in cyclic buffers that may contain random incident radiation interaction. A Neural State Machine may be used to monitor all sensor signals at a start time T0 for an interaction in an interaction window. When there is a valid trigger of a signal conditions at time T0, the triggering and input data control may enable saving of data in the cyclic buffers for a number of samples T0+Tpulse (e.g. until signal formation completed). It will then provide the input signal data around TO [T0−Thistory; T0+Tpulse], which may be referred to as an “event window”, for the semiconductor sensors to be processed by the ANN of the processing unit.

In one example signals from the semiconductor sensors flow from the converters (N-channels), where they are sampled at fixed frequency (e.g. 16 Mhz). These discrete signal values are saved/updated in the cyclic buffers (N-channels) at a location (M) for all N-buffers. The triggering and input data control may continuously search any signal conditions for a valid event trigger (e.g., any photon interaction within the detector volume) in N-channels at TO. If the signal conditions triggers at TO, data for a specific event may be prepared and provided to the ANN signal processing. The following steps may be used:
A) disabling of the trigger monitor
B) saving/updating discrete converted signals in the cyclic buffer for a given fixed time interval Tpulse (corresponding to a complete signal formation).
C) providing input data set of N×M sampling of all semiconductor sensors to the ANN signal processing and event characterization module
D) enabling trigger monitor after completion of step (C)

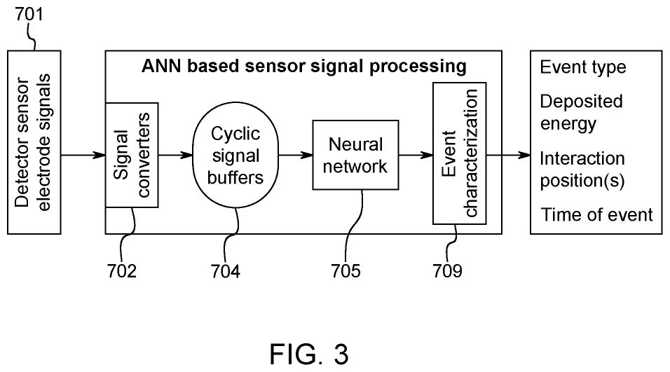

FIG. 3 shows an embodiment of a conceptual setup of the presently disclosed semiconductor radiation sensor device for characterizing X-ray and/or gamma-ray radiation. A semiconductor radiation sensor device first receives/senses X-ray and/or gamma-ray radiation (701). The charges in the converter are the converted to currents or voltages (702). The data is then further arranged and prepared for the artificial neural network (704) in a cyclic buffer. The signals/data read out from the converter is then used by an neural network (705) that has been trained to generate the estimated interaction time and the three-dimensional interaction position of the event based on a model of physical and geometrical properties of the plurality of semiconductor sensors. The processing unit can then perform an event characterization (709).

### Converter

The converter part of the presently disclosed semiconductor radiation sensor device may be implemented in various ways, as would be understood by a person skilled in the art.

Examples of such converter configurations may be found in, for example, WO2015078902 and WO2018065024.

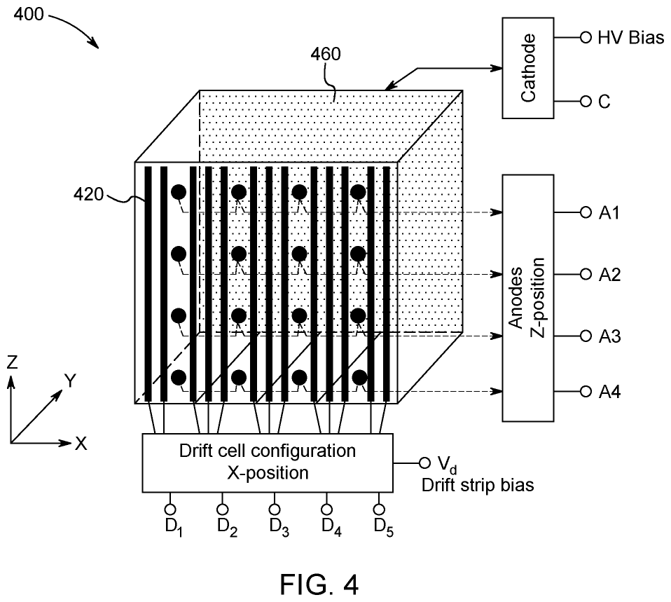

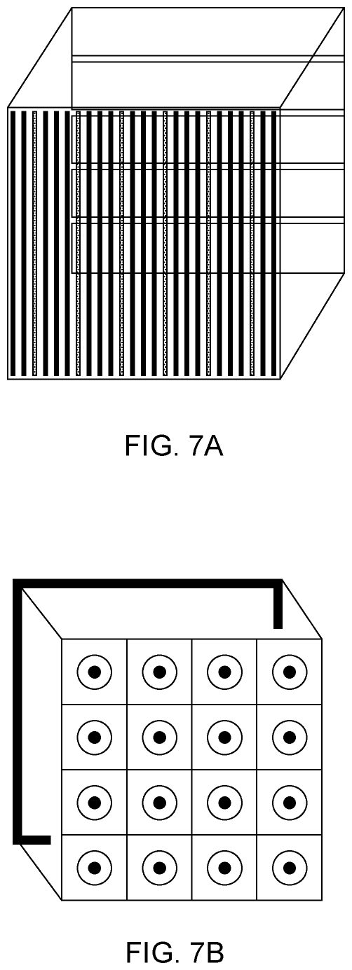

FIG. 4 shows an embodiment of a setup of electrodes and readout circuitry. FIG. 7A-D show a number of possible embodiments of electrodes that can be used in the presently disclosed converter. Other types or configurations of converters are not excluded. In one embodiment, the plurality of semiconductor sensors are cathode electrodes arranges on a first side of the converter, and wherein the converter has a second side opposite to the first side, wherein at least one anode electrode is arranged on the second side of the converter.

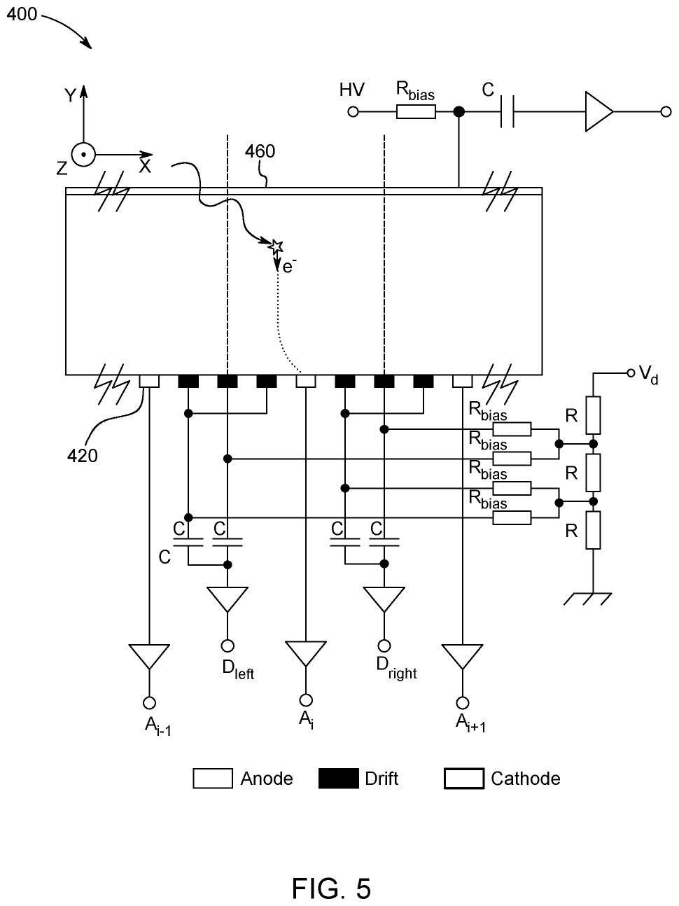

The converter may comprise a plurality of electrodes extending along a first axis with a pitch along a second axis, the second axis being perpendicular to the first axis. In FIG. 4 the anode strips (420) are arranged as parallel strips with a pitch in a perpendicular direction. The cathode strips may also be arranged as parallel strips. The anodes and cathodes are interchangeable. In FIG. 4 the cathode is implemented as a surface (460). FIG. 5 shows an embodiment of a conceptual setup of electrodes and readout circuitry. The presently disclosed semiconductor radiation sensor device for characterizing X-ray and/or gamma-ray radiation may be used on any detector and sensor geometry.

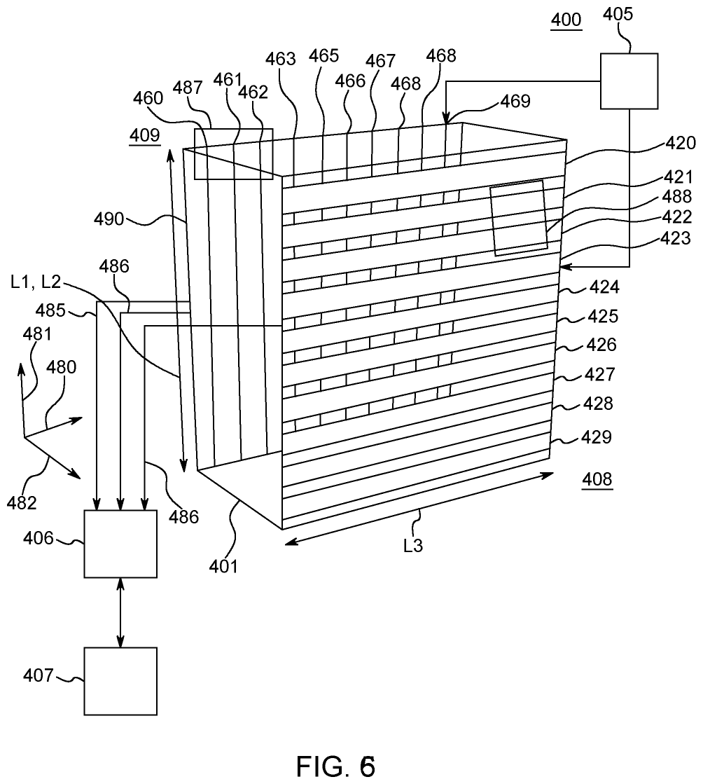

FIG. 6 shows a further example of a converter (400). The converter (400) comprises a converter element (401) for converting incident X-ray and/or gamma-ray photons into electron-hole pairs. The converter element (401) comprises a first side (408) and a second side (409) opposite to the first side (408). On the first side (408) 10 elongated parallel cathode strips (420-429) are arranged with a pitch, and on the second side (409) 10 elongated parallel detector strip electrodes (460-469) with a pitch are arranged. The detector strip electrodes (460-469) and the drift strip electrodes (431-438) both extend along a second axis (481), and the cathode strips (420-429) extend along a first axis (480) being perpendicular to the second axis (481). The cathode strip electrodes (420-429) and the drift strip electrodes (431-438) are both connected to a voltage source (405). The voltage source (405) is configured to provide the cathode strips (431-438) with a potential being negative relative to the potential of both the drift strip electrodes (431-438) and the detector strip electrodes (460-469), whereby holes propagate towards the cathode strip electrodes (420-429) and electrons are propagating toward the detector strip electrodes (460-469). The voltage source (405) is further configured to provide the drift strip electrodes (431-438) with a potential being negative relative to the potential of the detector strip electrodes (460-469), whereby the electrons are focused towards the detector strip electrodes (460-469). The converter 400 further comprises a readout circuitry (406) being configured to read out signals from the detector strip electrodes (460-469), the drift strip electrodes (431-438), and the cathode strip electrodes (420-429). The readout circuitry (406) is connected to a processing unit (407).

The converter may be a three-dimensional converter. More specifically the semiconductor radiation sensor device may comprise a three-dimensional CdZnTe converter capable of determining the interaction position of photons in three dimensions. The converter may also be based on CdTe, CdMnTe, HgI, TlBr, HgCdTe, PbI, InP, or GaAs. The signals from the plurality of semiconductor sensors may be sampled using a sampling frequency of at least 1 MHz, preferably at least 16 MHz.

### Readout Circuitry

The readout circuitry is used to read out the signals from said plurality of semiconductor sensors, and, at least to some extent, may also process the signals. In some embodiments the plurality of physically spaced semiconductor sensors have independent readout channels, and in some embodiments certain of the physically spaced semiconductor sensors are grouped.

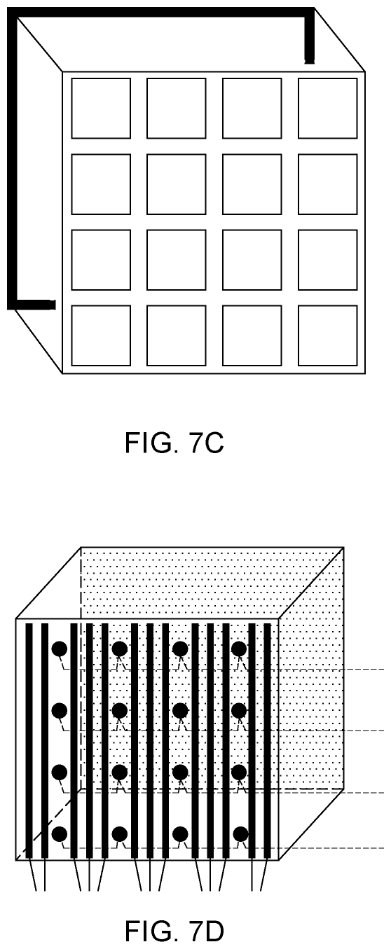

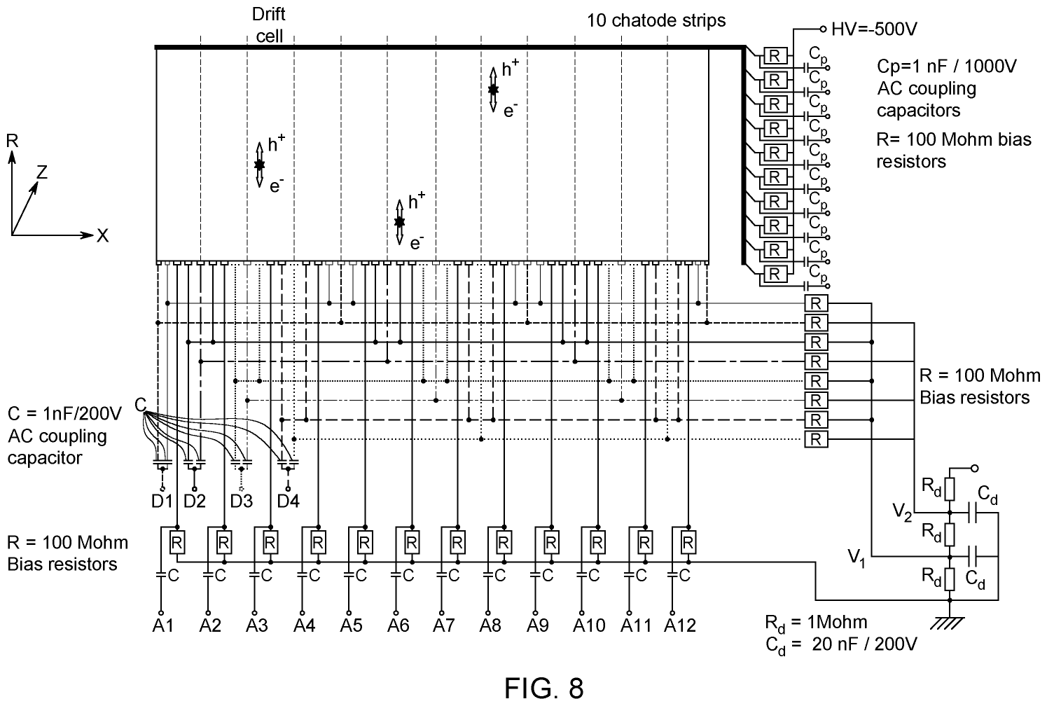

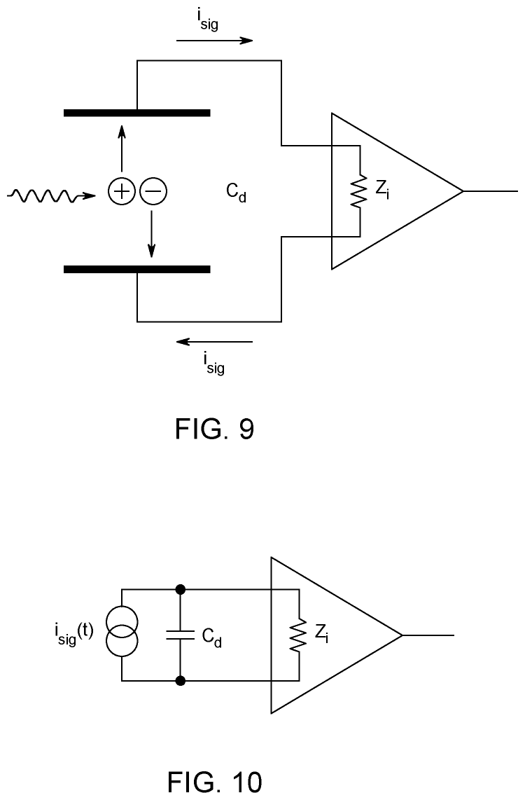

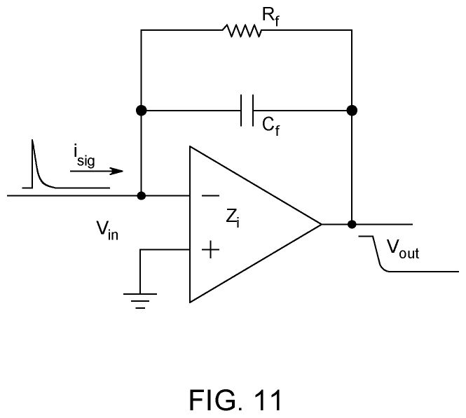

FIG. 8 shows an example of a readout circuitry of the present disclosed semiconductor radiation sensor device. In the example, the anodes are held at ground potential, while the cathodes are supplied with a potential, such as −350V for 5 mm thickness of CZT detector or any other suitable potential. This difference in bias ensures that the radiation-induced charge carriers begin to drift in the detector. The electrons move towards the anodes and the positively charged holes move toward the cathodes. A voltage divider supplies the drift strip with a bias. The bias for the drift strip has the effect, that the electrons are guided toward the anode where they are collected. In the example of FIG. 8 all of the drift strips are coupled to a total of 4 channels. Alternatively, the detector may have uncoupled drift strip signals. The drift electrode signals may be individual signals. The anode and cathode signals are all coupled to their own individual channels. The 26 signals (4 drift, 12 anodes and 10 cathodes) are read out as a voltage that is fed to a charge-sensitive pre-amplifier. FIG. 11 shows an example of a basic configuration of a charge sensitive pre-amplifier. FIG. 9 shows an embodiment of a signal converter for converting a charge to a current. FIG. 10 shows an electrical equivalent of the signal converter of FIG. 9. The readout circuitry may comprise any suitable type of amplifier. Accordingly, the readout circuitry may be configured to convert the signals from said plurality of semiconductor sensors to voltage pulses.

In one embodiment of the presently disclosed semiconductor radiation sensor device, the artificial neural network is configured to process sampled series of signals from the plurality of semiconductor sensors. The processing unit and the artificial neural network may be local components configured to operate offline in substantially real-time. This means that may not have time to, for example, send significant volumes of data to a server and wait for data to be processed.

The readout circuitry may comprise a converter that converts analog voltages or currents in the electric field generator to digital signals. The digital signals may then be arranged in cyclic buffers. The processing unit may be configured to search the cyclic buffers for interaction caused by the X-ray and/or gamma-ray radiation. When the processing unit detects interaction, the artificial neural network may process the digital signals from the plurality of physically spaced semiconductor sensors for an event time window.

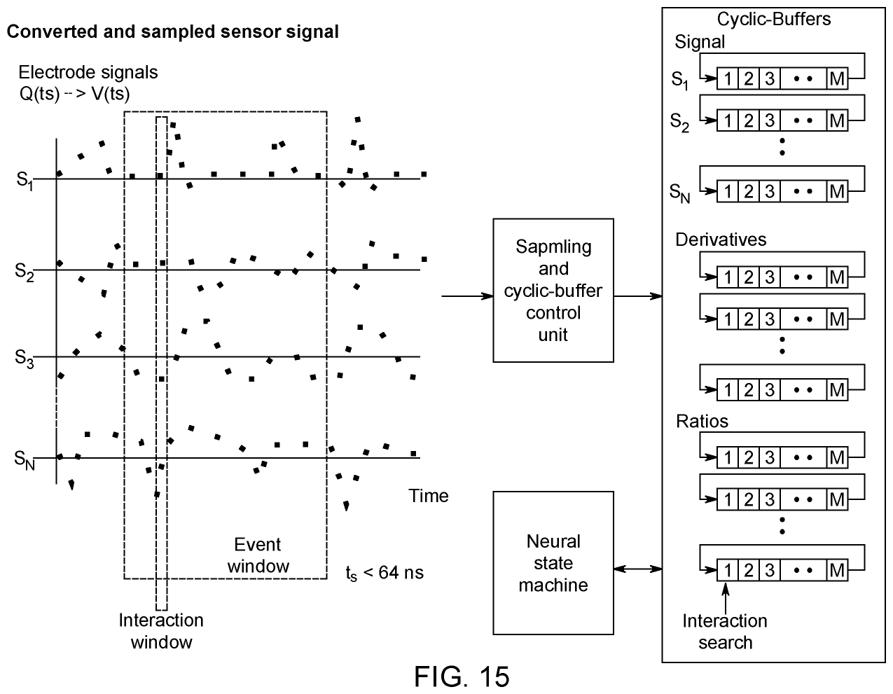

FIG. 15 shows an example of cyclic buffers used for sampling signals from the plurality of physically spaced semiconductor sensors. As can be seen a control unit may control how the signals are sampled, maintained in the cyclic buffers and sent to the artificial neural network.

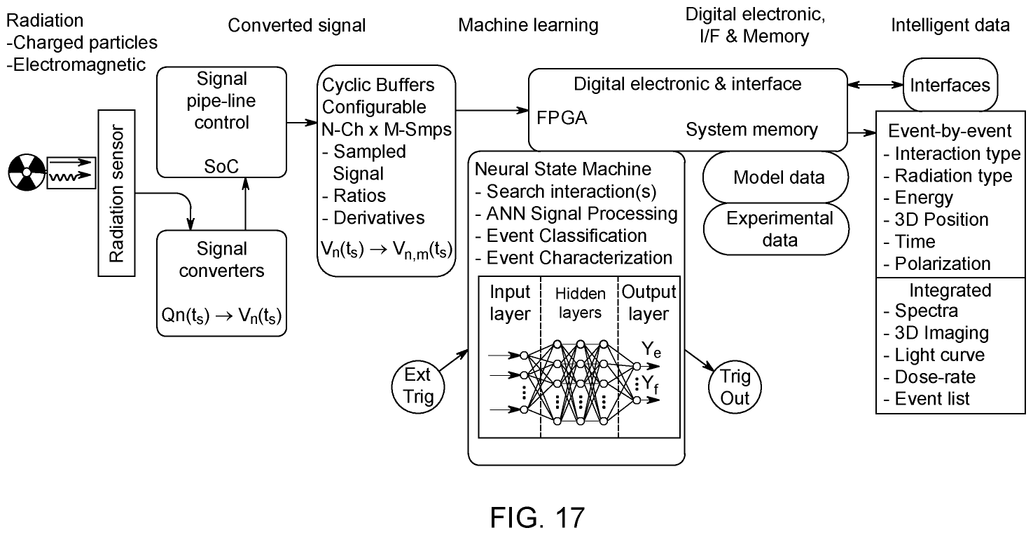

FIG. 17 shows a further schematic embodiment of the presently disclosed radiation sensor device. In this example, a detector detects radiation. A signal converter converts charges to currents or voltages. The sensor signals are converted and saved in cyclic buffers. The system further comprises a neural state machine that monitors all sensor signals at for an interaction in an interaction window.

### Model, Artificial Neural Network

As stated above, the inventor of the presently disclosed semiconductor radiation sensor device for characterizing X-ray and/or gamma-ray radiation has realized that in order to make the new generation devices, including, for example three-dimensional CZT drift strip detectors, capable of characterizing events in substantially real-time, an option is to use a processing unit with an artificial neural network configured to estimate an interaction time and a three-dimensional interaction position of an event in said converter by processing the signals read out from the plurality of semiconductor sensors.

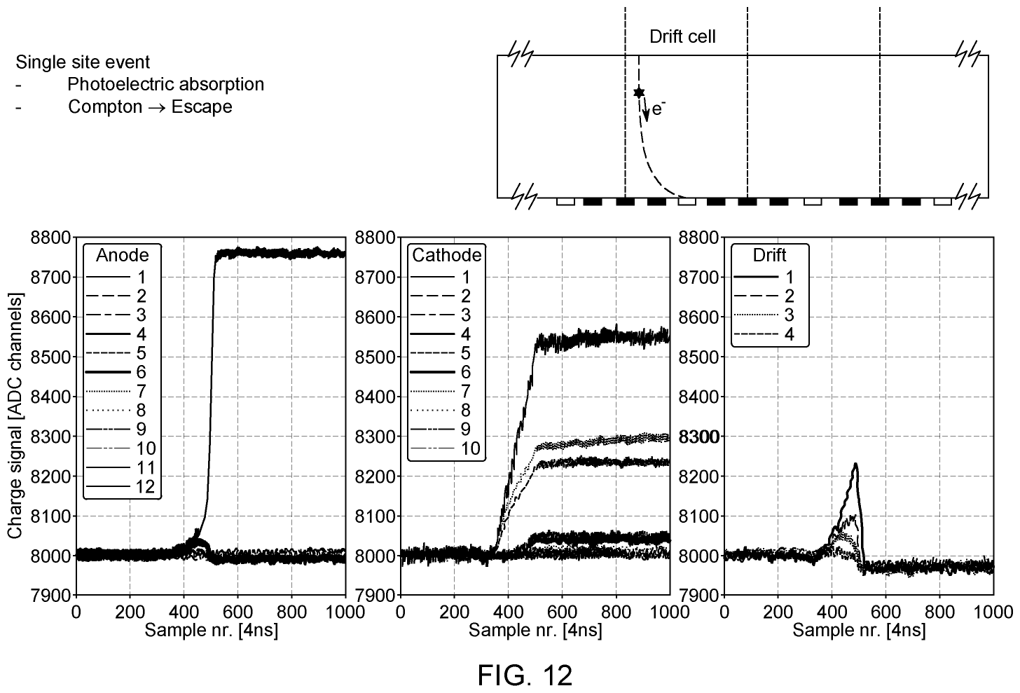

FIG. 12 shows an example of signal of charges on the electrodes for a setup as shown in FIG. 4. Sampled data from such signals from a total of 26 channels (12 anode, 10 cathode, 4 drift) can be used to train the ANN to estimate interaction type, interaction position, deposited energies or electron drift time. FIG. 12 shows an example of a single site event.

The model of physical and geometrical properties of the plurality of semiconductor sensors may comprise a three-dimensional electrostatic model of the plurality of electrodes. The model of physical and geometrical properties of the plurality of semiconductor sensors may be a sensor specific mathematical model of physical and geometrical properties of the plurality of semiconductor sensors, meaning that the artificial neural network can be trained for any suitable specific conditions and physical arrangements. Preferably, the model of physical and geometrical properties of the plurality of semiconductor sensors is a sensor specific model that describes an electrostatic model of the converter, charge carrier transport and signal formation on the electrodes. The model may use imported material characteristics from a manufacturer of the semiconductor sensors. The model of physical and geometrical properties of the plurality of semiconductor sensors may comprise a model of the materials of the semiconductor sensors, preferably wherein the model describes the process of converting incident X-ray and/or gamma-ray photons into electron-hole pairs. The model may comprise geometrical properties, electrical properties and charge transport properties. In the model a simulation of movement of a single charge or a multiple charges may be performed. The model of physical and geometrical properties of the plurality of semiconductor sensors may comprise a model of charge carrier transport of the plurality of semiconductor sensors. The model of physical and geometrical properties of the plurality of semiconductor sensors may comprise signal formation models of the plurality of semiconductor sensors. In one embodiment, the semiconductors are assumed to be uniform. Once a sensor specific model has been established it is possible to simulate time-varying charges on the plurality of semiconductor sensors. Accordingly, a range of scenarios of X-ray and/or gamma-ray radiation and their responses in the form of read out currents and/or voltages can be simulated.

The artificial neural network may be trained using simulated data on a specific theoretical model of the semiconductor sensors. Furthermore, the artificial neural network may be trained based on the model of physical and geometrical properties of the plurality of semiconductor sensors using synthetic data.

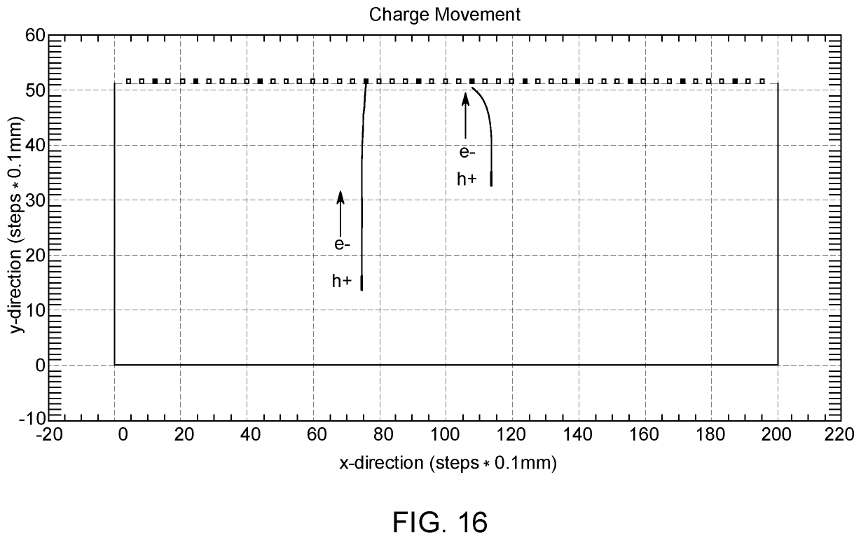

FIG. 16 shows an example of an output of a theoretical sensor specific model, more precisely the modelling of charge movement after an event.

The inventor has found that rather than calculating an interaction time and a three-dimensional interaction position, an artificial neural network trained to recognize patterns of the monitored time series of signals to estimate the interaction time and position of the event is an efficient and accurate way of approaching the task. In one embodiment of the presently disclosed semiconductor radiation sensor device for characterizing X-ray and/or gamma-ray radiation, the artificial neural network has been trained to recognize patterns of the incident X-ray and/or gamma-ray photons on the plurality of semiconductor sensors and corresponding sampled signals read out from the plurality of semiconductor sensors. The artificial neural network may thus be trained based on the model itself and/or in combination with the read-outs from the actual internal arrangements and specific physical properties of the plurality of semiconductor sensors.

Neural networks are a part of the subgenre of artificial intelligence known as machine learning. The method is especially useful for revealing new and hidden structures in datasets, as it is not limited by human knowledge or perception. In the presently disclosed semiconductor radiation sensor device for characterizing X-ray and/or gamma-ray radiation, experiments with datasets comprising time series observations simulated by the model of physical and geometrical properties of the plurality of semiconductor sensors have been performed.

### EXAMPLE—EXPERIMENTAL SETUP

The invention has been tested in an experimental setup, which shall not be seen as limiting for the invention, but merely an exemplary embodiment.

In the setup, the neural network used a loss function to update parameters of the neural network. The loss function can be given as the squared L2 norm, also known as the
mean squared error.

$$L = \frac{1}{N} {\sum }_{i = 1}^{N} {( {x}_{i} - {y}_{i} )}^{2}$$

N is the number of observation in a given batch.

The loss function is what is optimized in the training process.

A sigmoid function was used as activation function:

$$S ( x ) = \frac{1}{1 + {exp}^{- x}}$$

Four different optimization algorithms were tested: SGD, RMSprop, Momentum and Adam. They were applied to train the network on a training set composed of data from a previous theoretical model. It is the assumption that the results found can be directly applied to the new theoretical model as well. For each method, different hyperparameter configurations were tested and compared, and the configuration with the lowest mean square error (MSE) was chosen as a representative. The best configurations for each method were then tested against each other. All tests were performed for 50 epochs, with a batch size of 1000. Identical splits were used for all comparisons. Due to the random nature of each initialization and split, the conclusions were drawn by comparison of several identical test runs.

The number of hidden layers tested were 1, 2, 5, 10 and 15. The networks were trained for 1000 epochs on the rough 5 mm grid 50,27,100 dataset. A learning rate of 10⁻³ was used and networks consisting of 5, 10, 50, 100 and 200 neurons were trained.

The number of neurons in the output layer is always 3, one for each coordinate designating the interaction position. The number of input neurons are pre-determined by the resampling frequency. It is equal to 26×Z, where Z is the number of datapoints describing a single electrode. It is given as 400, 100, 50 and 25 for the 250 MHz, 62.5 MHz, 31.25 MHz and 15.625 MHz respectively, resulting in the associated number of neurons in the input layers being 10400, 2600, 1300 and 650. Based on the learning curves for the chosen number of hidden layers in the previous optimization, a preliminary estimate for the number of neurons in the hidden layers were made. The other hyperparameters remained the same as in the hidden layer optimization, except for the number of epochs which was reduced to 700. The rough grid 0.5 mm 50,27,100 resampled datasets were used. For the resampling frequencies of 62.5 MHz, 31.5 MHz and 15.625 MHz the lowest training error in the hidden layer optimization was found between 5 and 10 neurons. So configurations consisting of 1, 3, 5, 7, 10, 12, 15, 17 and 20 neurons were investigated. Again, the number of neurons in each hidden layer was the same for simplicity's sake. The lowest test error for 250 MHz was found around 50 neurons, so configurations with 30, 35, 40, 45, 50, 55, 60, 65 and 70 neurons were tested. The chosen number of neurons were 40 for 250 MHz, 12 for 62.5 MHz, 15 for 31.25 MHz and 20 for 15.625 MHz.

Table 1 is a summary of hyperparameters for the different resampling frequencies.

TABLE 1

| | Resampling frequency | | | |
|---|---|---|---|---|
| Hyperparameter | 250 MHz | 125 MHz | 62.5 MHz | 15.625 MHz |
| activation function | sigmoid | sigmoid | sigmoid | sigmoid |
| optimization method | Adam | Adam | Adam | Adam |
| # hidden layers | 2 | 2 | 2 | 2 |
| # neurons (input layer) | 650 | 1300 | 2600 | 10400 |
| # neurons (hidden | 20 | 15 | 12 | 40 |
| layers) | | | | |
| # neurons (output | 3 | 3 | 3 | 3 |
| layer) | | | | |
| learning rate | 1e−3 | 1e−3 | 1e−3 | 1e−4 |

Performance of the neural networks have been evaluated in terms of capability of determining the 3D interaction position for photons in a CZT detector. Both slit beam and spiral datasets were used to verify the position determination ability of each network.

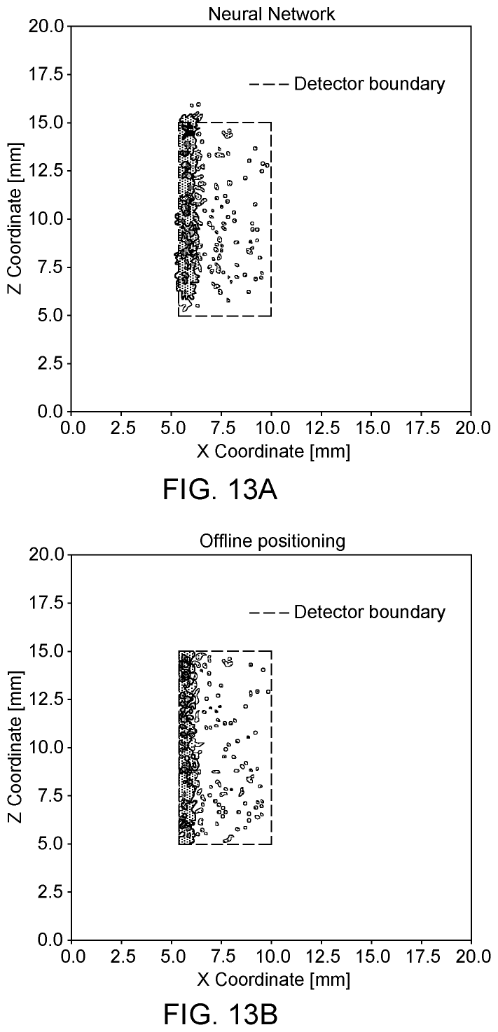

FIG. 13 shows a 2D histogram showing the location of events from the slit beam illuminating detector surface in the xz plane. Experimental data of Gamma-ray image of Cs137, 662 keV source is obtained by a small Gamma-ray detector setup. FIG. 13A shows the result of conventional pulse-shape processing. FIG. 13B shows the result of ANN based signal processing. The axes show the detector size, while the dotted lines indicate detector subset of allowed event locations. The cut off of an substantial amount of the beam is noticeable in the figure depicting the offline positioning algorithm predicted positions. In contrast, the data is fully enclosed by the detector subset in the figure for the neural network predicted data. There is a slight overall offset of the positions in the z direction, as noted by the events located above the high z boundary, as well as the fact that no events are located all the way down to the low z boundary. This fact does not by itself give any information or credit to either of the positioning methods.

The presently disclosed semiconductor radiation sensor device for characterizing X-ray and/or gamma-ray radiation may be used in a number of devices, including, but not limited to, X-ray imagers, IR sensors, silicon strip detector and space applications. The present disclosure relates to a medical device, such as a medical imaging device, comprising any embodiment of the presently disclosed semiconductor radiation sensor device. The disclosure further relates to a spacecraft, such as a satellite, comprising any embodiment of the presently disclosed semiconductor radiation sensor device. A spacecraft may be any type of manned or unmanned vehicle or object design for outer space. According to a broad definition, this may also include any object, such as a satellite, that can be placed into orbit around a celestial body.

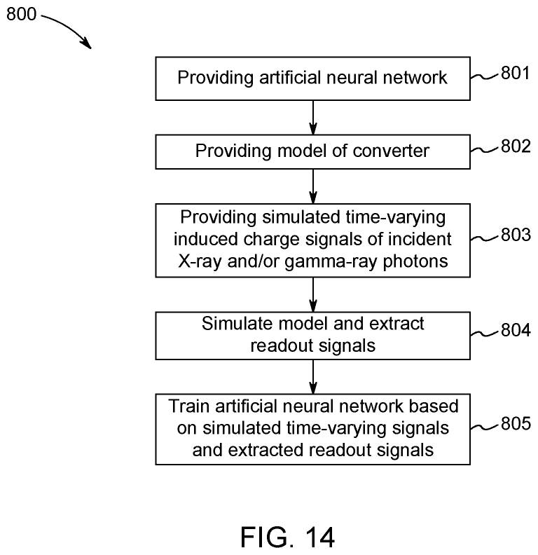

The present disclosure further relates to a method of training an artificial neural network. FIG. 14 shows a flow chart of a method (800) according to an embodiment of the presently disclosed method of training an artificial neural network. The method (800) comprises the steps of:
providing an artificial neural network (801);
providing a model of a converter comprising a plurality of semiconductor sensors for converting incident X-ray and/or gamma-ray photons into electron-hole pairs, the model further comprising physical and geometrical properties of the plurality of semiconductor sensors (802);
providing simulated time-varying induced charge signals of incident X-ray and/or gamma-ray photons on the plurality of semiconductor sensors (803);
based on further simulations of the model of the converter and the simulated time-varying induced charge signals on the plurality of semiconductor sensors, extracting simulated read out signals from the plurality of semiconductor sensors (804); and
based on the simulated time-varying induced charge signals of incident X-ray and/or gamma-ray photons on the plurality of semiconductor sensors and the simulated read out signals from the plurality of semiconductor sensors, training the artificial neural network to generate a three-dimensional characterization of incoming single photons (805).

The method may comprise the step of developing the model of a converter comprising a plurality of semiconductor sensors for converting incident X-ray and/or gamma-ray photons into electron-hole pairs, the model further comprising physical and geometrical properties of the plurality of semiconductor sensors. The model may be any of the presently disclosed embodiments of the model of the.

The method may further comprise the step of creating the time-varying induced charge signals of incident X-ray and/or gamma-ray photons.

The method may further comprise the step of running simulations of the model, applying the time-varying induced charge signals of incident X-ray and/or gamma-ray photons to obtain simulated read out signals from the plurality of semiconductor sensors.

The invention further relates to a computer program having instructions which when executed by a computing device or computing system cause the computing device or system to carry out any embodiment of the presently disclosed method for training an artificial neural network.

### FURTHER DETAILS

1. A semiconductor radiation sensor device for characterizing X-ray and/or gamma-ray radiation comprising:
a converter comprising a plurality of physically spaced semiconductor sensors configured to convert incident X-ray and/or gamma-ray photons into electron-hole pairs;
an electric field generator configured to apply an electric field to the plurality of physically spaced semiconductor sensors, thereby creating signals representative of a movement of charge carriers in the physically spaced semiconductor sensors;
a readout circuitry being configured to read out the signals from said plurality of semiconductor sensors; and
a processing unit connected to said readout circuitry, said processing unit being configured to estimate an interaction time and a three-dimensional interaction position of an event in said converter by processing the signals read out from the plurality of semiconductor sensors, wherein the processing unit comprises an artificial neural network that has been trained to generate the estimated interaction time and the three-dimensional interaction position of the event based on a model of physical and geometrical properties of the plurality of semiconductor sensors and based on simulated time-varying charges on the plurality of semiconductor sensors.

2. The semiconductor radiation sensor device according to item 1, wherein the processing unit is configured to estimate the interaction time and the three-dimensional interaction position of the event in substantially real-time by feeding the readout signals to the artificial neural network and obtaining the interaction time and the three-dimensional interaction position of the event.

3. The semiconductor radiation sensor device according to any one of the preceding items, wherein the event is an interaction between an X-ray or gamma-ray photon and the converter.

4. The semiconductor radiation sensor device according to any one of the preceding items, wherein the processing unit is configured to estimate an energy level of an X-ray or gamma-ray photon.

5. The semiconductor radiation sensor device according to any one of the preceding items, wherein the converter comprises a plurality of electrodes extending along a first axis with a pitch along a second axis, the second axis being perpendicular to the first axis.

6. The semiconductor radiation sensor device according to any one of the preceding items, wherein the plurality of semiconductor sensors are cathode electrodes arranges on a first side of the converter, and wherein the converter has a second side opposite to the first side, wherein at least one anode electrode is arranged on the second side of the converter.

7. The semiconductor radiation sensor device according to any one of the preceding items, wherein the model of physical and geometrical properties of the plurality of semiconductor sensors comprises a three-dimensional electrostatic model of the plurality of electrodes.

8. The semiconductor radiation sensor device according to any one of the preceding items, wherein the model of physical and geometrical properties of the plurality of semiconductor sensors is a sensor specific mathematical model of physical and geometrical properties of the plurality of semiconductor sensors.

9. The semiconductor radiation sensor device according to any one of the preceding items, wherein the model of physical and geometrical properties of the plurality of semiconductor sensors comprises a model of the materials of the semiconductor sensors, preferably wherein the model describes the process of converting incident X-ray and/or gamma-ray photons into electron-hole pairs.

10. The semiconductor radiation sensor device according to any one of the preceding items, wherein the model of physical and geometrical properties of the plurality of semiconductor sensors comprises a model of charge carrier transport of the plurality of semiconductor sensors.

11. The semiconductor radiation sensor device according to any one of the preceding items, wherein the model of physical and geometrical properties of the plurality of semiconductor sensors comprises signal formation models of the plurality of semiconductor sensors.

12. The semiconductor radiation sensor device according to any one of the preceding items, wherein the processing unit and the artificial neural network are local components configured to operate offline.

13. The semiconductor radiation sensor device according to any one of the preceding items, wherein the artificial neural network has been trained based on internal arrangements and specific physical properties of the plurality of semiconductor sensors.

14. The semiconductor radiation sensor device according to any one of the preceding items, wherein the three-dimensional characterization of incoming single photons comprises interaction types and/or interaction positions and/or deposited energies and/or time stamps.

15. The semiconductor radiation sensor device according to any one of the preceding items, wherein the artificial neural network has been trained to recognize patterns of the incident X-ray and/or gamma-ray photons on the plurality of semiconductor sensors and corresponding sampled signals read out from the plurality of semiconductor sensors.

16. The semiconductor radiation sensor device according to any one of the preceding items, wherein the readout circuitry comprises amplifiers.

17. The semiconductor radiation sensor device according to any one of the preceding items, wherein the readout circuitry is configured to convert the signals from said plurality of semiconductor sensors to voltage pulses.

18. The semiconductor radiation sensor device according to any one of the preceding items, wherein the converter is a three-dimensional converter, such as a Cadmium Zinc Telluride (CZT) converter, preferably a room temperature converter.

19. The semiconductor radiation sensor device according to any one of the preceding items, wherein signals from the plurality of semiconductor sensors are sampled using a sampling frequency of at least 1 MHz.

20. A medical device, such as a medical imaging device, comprising the semiconductor radiation sensor device according to any one items 1-19.

21. A spacecraft, such as a satellite, comprising the semiconductor radiation sensor device according to any one items 1-19.

22. A method of training an artificial neural network, the method comprising the step of:
providing an artificial neural network;
providing a model of a converter comprising a plurality of semiconductor sensors for converting incident X-ray and/or gamma-ray photons into electron-hole pairs, the model further comprising physical and geometrical properties of the plurality of semiconductor sensors;
providing simulated time-varying induced charge signals of incident X-ray and/or gamma-ray photons on the plurality of semiconductor sensors;
based on further simulations of the model of the converter and the simulated time-varying induced charge signals on the plurality of semiconductor sensors, extracting simulated read out signals from the plurality of semiconductor sensors; and
based on the simulated time-varying induced charge signals of incident X-ray and/or gamma-ray photons on the plurality of semiconductor sensors and the simulated read out signals from the plurality of semiconductor sensors, training the artificial neural network to generate a three-dimensional characterization of incoming single photons.

23. A computer program having instructions which, when executed by a computing device or computing system, cause the computing device or computing system to carry out the method of training an artificial neural network according to item 22.

1. A semiconductor radiation sensor device for characterizing X-ray and/or gamma-ray radiation comprising:
a converter comprising a plurality of physically spaced semiconductor sensors configured to convert incident X-ray and/or gamma-ray photons into electron-hole pairs;
an electric field generator configured to apply an electric field to the plurality of physically spaced semiconductor sensors, thereby creating signals representative of a movement of charge carriers in the physically spaced semiconductor sensors;
a readout circuitry being configured to read out the signals from said plurality of semiconductor sensors; and
a processing unit connected to said readout circuitry, said processing unit being configured to estimate an interaction time and a three-dimensional interaction position of an event in said converter by processing the signals read out from the plurality of semiconductor sensors, wherein the processing unit comprises an artificial neural network that has been trained to generate the estimated interaction time and the three-dimensional interaction position of the event based on a model of physical and geometrical properties of the plurality of semiconductor sensors and based on simulated time-varying charges on the plurality of semiconductor sensors.

2. The semiconductor radiation sensor device according to claim 1, wherein the processing unit is configured to estimate the interaction time and the three-dimensional interaction position of the event in substantially real-time by feeding the readout signals to the artificial neural network and obtaining the interaction time and the three-dimensional interaction position of the event.

3. The semiconductor radiation sensor device according to any one of the preceding claims, wherein the artificial neural network is configured to process sampled series of signals from the plurality of semiconductor sensors.

4. The semiconductor radiation sensor device according to any one of the preceding claims, wherein the processing unit and the artificial neural network are local components configured to operate offline in substantially real-time.

5. The semiconductor radiation sensor device according to any one of the preceding claims, comprising a converter that converts analog voltages or currents in the electric field generator to digital signals.

6. The semiconductor radiation sensor device according to claim 5, wherein the digital signals are arranged cyclic buffers.

7. The semiconductor radiation sensor device according to claim 6, wherein the processing unit is configured to search the cyclic buffers for interaction caused by the X-ray and/or gamma-ray radiation.

8. The semiconductor radiation sensor device according to claim 7, wherein the processing unit, upon detection of interaction, uses the artificial neural network to process the digital signals from the plurality of physically spaced semiconductor sensors for an event time window.

9. The semiconductor radiation sensor device according to any one of the preceding claims, wherein the event is an interaction between an X-ray or gamma-ray photon and the converter.

10. The semiconductor radiation sensor device according to any one of the preceding claims, wherein the processing unit is configured to estimate an energy level of an X-ray or gamma-ray photon.

11. The semiconductor radiation sensor device according to any one of the preceding claims, wherein the converter comprises a plurality of electrodes extending along a first axis with a pitch along a second axis, the second axis being perpendicular to the first axis.

12. The semiconductor radiation sensor device according to any one of the preceding claims, wherein the plurality of semiconductor sensors are cathode electrodes arranges on a first side of the converter, and wherein the converter has a second side opposite to the first side, wherein at least one anode electrode is arranged on the second side of the converter.

13. The semiconductor radiation sensor device according to any one of the preceding claims, wherein the model of physical and geometrical properties of the plurality of semiconductor sensors comprises a three-dimensional electrostatic model of the plurality of electrodes.

14. The semiconductor radiation sensor device according to any one of the preceding claims, wherein the model of physical and geometrical properties of the plurality of semiconductor sensors is a sensor specific mathematical model of physical and geometrical properties of the plurality of semiconductor sensors.

15. The semiconductor radiation sensor device according to any one of the preceding claims, wherein the model of physical and geometrical properties of the plurality of semiconductor sensors comprises a model of the materials of the semiconductor sensors, preferably wherein the model describes the process of converting incident X-ray and/or gamma-ray photons into electron-hole pairs.

16. The semiconductor radiation sensor device according to any one of the preceding claims, wherein the model of physical and geometrical properties of the plurality of semiconductor sensors comprises a model of charge carrier transport of the plurality of semiconductor sensors.

17. The semiconductor radiation sensor device according to any one of the preceding claims, wherein the model of physical and geometrical properties of the plurality of semiconductor sensors comprises signal formation models of the plurality of semiconductor sensors.

18. The semiconductor radiation sensor device according to any one of the preceding claims, wherein the artificial neural network that has been trained using simulated data on a specific theoretical model of the semiconductor sensors.

19. The semiconductor radiation sensor device according to any one of the preceding claims, wherein the artificial neural network is trained based on the model of physical and geometrical properties of the plurality of semiconductor sensors using synthetic data.

20. A medical device, such as a medical imaging device, comprising the semiconductor radiation sensor device according to any one of claims 1-19.

21. A spacecraft, such as a satellite, comprising the semiconductor radiation sensor device according to any one of claims 1-19.

22. A method of training an artificial neural network, the method comprising the step of:
providing an artificial neural network;
providing a model of a converter comprising a plurality of semiconductor sensors for converting incident X-ray and/or gamma-ray photons into electron-hole pairs, the model further comprising physical and geometrical properties of the plurality of semiconductor sensors;
providing simulated time-varying induced charge signals of incident X-ray and/or gamma-ray photons on the plurality of semiconductor sensors;
based on further simulations of the model of the converter and the simulated time-varying induced charge signals on the plurality of semiconductor sensors, extracting simulated read out signals from the plurality of semiconductor sensors; and
based on the simulated time-varying induced charge signals of incident X-ray and/or gamma-ray photons on the plurality of semiconductor sensors and the simulated read out signals from the plurality of semiconductor sensors, training the artificial neural network to generate a three-dimensional characterization of incoming single photons.

23. A computer program having instructions which, when executed by a computing device or computing system, cause the computing device or computing system to carry out the method of training an artificial neural network according claim 22.
